(19) United States
(12) Patent Application Publication
(10) Pub. No.: US 2022/0078571 A1
(43) Pub. Date: Mar. 10, 2022

(54) 3D RECORDING AND PLAYING METHOD AND LAPTOP WITH FUNCTION OF 3D RECORDING AND PLAYING

(71) Applicants: Inventec (Pudong) Technology Corporation, Shanghai (CN); INVENTEC CORPORTION, Taipei (TW)

(72) Inventors: Kuo-Chi TING, Taipei (TW); Yi-Lun Cheng, Taipei (TW); Chih-Kai Yang, Taipei (TW)

(21) Appl. No.: 17/029,380

(22) Filed: Sep. 23, 2020

(30) Foreign Application Priority Data
Sep. 7, 2020 (CN) 202010927045.9

(51) Int. Cl. H04S 1/00; H04S 7/00; H04R 3/04; H04R 3/14; H04R 5/04

(52) U.S. Cl. CPC H04S 1/005; H04S 7/304; H04R 3/04; H04R 2203/12; H04R 5/04; H04S 2420/01; H04R 3/14

(57) ABSTRACT

A 3D recording and playing method is applied to a laptop which has sound receiving elements and two audio output elements. The 3D recording and playing method comprises receiving input signals by the sound receiving elements, localizing and separating the input signals so as to obtain preliminarily processed signals, filtering each of the preliminarily processed signal using a head related transfer function to generate a left channel signal and a right channel signal, generating a left channel signal set according to the left channel signal corresponding to each of the preliminarily processed signals, and generating a right channel signal set according to the right channel signal corresponding to each of the preliminarily processed signals, and outputting the left channel signal set and the right channel signal set by the two audio output elements respectively.

### CROSS-REFERENCE TO RELATED APPLICATIONS

This non-provisional application claims priority under 35 U.S.C. § 119(a) on Patent Application No(s). 202010927045.9 filed in China on Sep. 7, 2020, the entire contents of which are hereby incorporated by reference.

### BACKGROUND

### 1. Technical Field

This invention relates to a three-dimensional (3D) recording and playing method, and particularly to a 3D recording and playing method applied to a laptop.

### 2. Related Art

The audio signals obtained by the recording method of the current laptop cannot provide a stereo sound effect or allow a user to have a strong sense of the direction of sounds, and cannot provide an immersive experience. This feeling is obvious during video conferencing. When the user is farther away, the audio signals obtained by the recording method of the current laptop is only quieter without other changes, so the audio signals will sound duller and not lively enough.

### SUMMARY

Accordingly, this invention provides a three-dimensional (3D) recording and playing method and a laptop with a function of 3D recording and playing.

According to an embodiment of this invention, a 3D recording and playing method is applied to a laptop which has sound receiving elements and two audio output elements. The 3D recording and playing method comprises receiving input signals by the sound receiving elements, localizing and separating the input signals so as to obtain preliminarily processed signals, for each of the preliminarily processed signals, filtering the preliminarily processed signal using a head related transfer function to generate a left channel signal and a right channel signal, generating a left channel signal set according to the left channel signal corresponding to each of the preliminarily processed signals, and generating a right channel signal set according to the right channel signal corresponding to each of the preliminarily processed signals, and outputting the left channel signal set and the right channel signal set by the two audio output elements respectively.

According to an embodiment of this invention, a laptop with a function of 3D recording and playing comprises sound receiving elements, two audio output elements and a processor. The sound receiving elements are configured to receive input signals respectively. The processor is connected with the sound receiving elements and the two audio output elements, and configured to localize and separate the input signals so as to obtain preliminarily processed signals, for each of the preliminarily processed signals, filter the preliminarily processed signal using a head related transfer function to generate a left channel signal and a right channel signal, generate a left channel signal set according to the left channel signal corresponding to each of the preliminarily processed signals, generate a right channel signal set according to the right channel signal corresponding to each of the preliminarily processed signals, and output the left channel signal set and the right channel signal set by the two audio output elements respectively.

In view of the above, the 3D recording and playing method and the laptop with the function of 3D recording and playing disclosed by this invention process the sound received by sound receiving elements through localization, separation and HRTF to obtain audio signals having a stereo sound effect which allows a user to have a strong sense of the direction of sounds, as if the user's ears are listening near sound sources.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram of an electronic device with a function of 3D recording and playing according to an embodiment of this invention;

FIG. 2 is a flow chart of a three-dimensional (3D) recording and playing method according to an embodiment of this invention; and

FIG. 3 is a flow chart of a 3D recording and playing method according to another embodiment of this invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

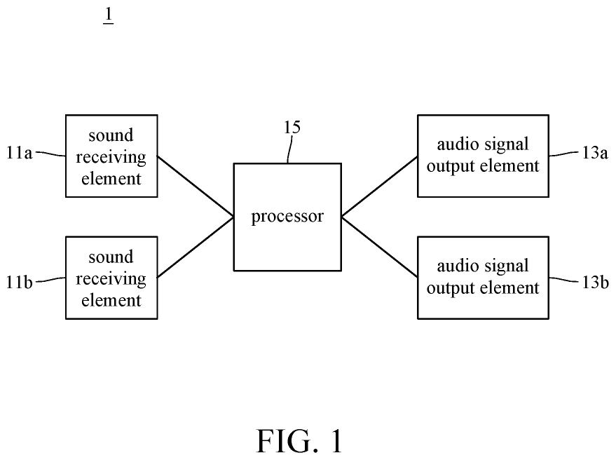

Please refer to FIG. 1, which is a functional block diagram of an electronic device with a function of three-dimensional (3D) recording and playing according to an embodiment of this invention. An electronic device 1 comprises sound receiving elements 11a and 11b, audio output elements 13a and 13b, and a processor 15, wherein the processor 15 is connected with the sound receiving elements 11a and 11b and the audio output elements 13a and 13b. Especially, the electronic device 1 can be implemented by a laptop, wherein the sound receiving elements 11a and 11b can be microphones of the laptop which form a microphone array. FIG. 1 exemplarily illustrates two sound receiving elements 11a and 11b; however, the number of the sound receiving elements of this invention is not limited to this. In particular, the arrangement of the microphone array can be designed based on an acoustic theory propagation model, and especially designed as a uniform circular array (UCA). The audio output elements 13a and 13b can be the two speakers of the laptop, wherein when a user uses the laptop, one of the audio output elements 13a and 13b is close to the user's left ear (left speaker), and the other one of the audio output elements 13a and 13b is close to the user's right ear (right speaker); or, the audio output elements 13a and 13b can respectively be the right side and left side of headphones which is connected with the laptop through headphone jack and the hole of headphone jack on the laptop. The processor 15 can be the central processing unit of the laptop.

The electronic device 1 can receive input signals by the sound receiving elements 11a and 11b, perform 3D processing, especially localization, separation and processing using head related transfer function (HRTF), on the input signals by the processor 15, and then output the processed audio signals by the audio output elements 13a and 13b. The detailed execution content of the 3D processing is described later. It should be noted that FIG. 1 exemplarily illustrates the components used by the electronic device 1 for performing the function of 3D recording and playing and does not intend to limit the electronic device to merely include the components as shown. In other embodiments, the electronic device can include other common components of a laptop, such as memory, display circuit, etc., which are not described in detail herein.

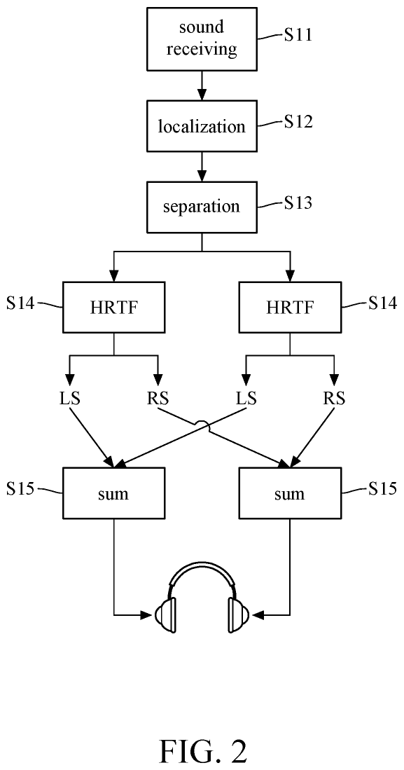

Please refer to FIG. 1 and FIG. 2, wherein FIG. 2 is a flow chart of a 3D recording and playing method according to an embodiment of this invention. The 3D recording and playing method shown in FIG. 2 is applied to the electronic device 1 as shown in FIG. 1, especially a laptop. As shown in FIG. 2, a 3D recording and playing method can comprise step S11 “sound receiving”, step S12 “localization”, step S13 “separation”, step S14 “HRTF”, step S15 “sum” and the step of outputting the processed signal at the end. The following exemplarily describes that the 3D recording and playing method in FIG. 2 is performed by the electronic device 1 in FIG. 1; however, this invention does not limit the 3D recording and playing method to only be applied to the electronic device 1 shown in FIG. 1.

In step S11, the electronic device 1 receives input signals by the sound receiving elements 11a and 11b, wherein the input signals are sound signals that are received by the sound receiving elements 11a and 11b from multiple sound sources in the environment outside the electronic device 1.

In step S12 and step S13, the electronic device 1 localizes and separates the input signals by the processor 15 so as to obtain preliminarily processed signals, wherein the number of preliminarily processed signals can correspond to the number of the sound sources, and particularly be the same as the number of the sound sources. Taking FIG. 1 as an example, it illustrates that two preliminarily processed signals are obtained after the localization step S12 and the separation step S13 and then the subsequent step S14 is individually performed on the two preliminarily processed signals, which indicates that the number of the sound sources of the input signals received by the sound receiving elements 11a and 11b is two. In particular, the processor 15 can perform the localization of the sound sources in the space during sound receiving and separate the signals respectively corresponding to the different sound sources from the input signals based on a beamforming algorithm.

More particularly, the processor 15 can perform the above-mentioned localization and separation based on delay-and-sum (DAS) algorithm, minimum power distortionless response (MPDR) algorithm, minimum variance distortionless response (MVDR) algorithm or other beamforming algorithm.

The processor 15 can consider the signals generated by the above-mentioned localization and separation using the beamforming algorithm as preliminarily processed signals; or, after performing beamforming algorithm, the processor 15 can perform further separation using pseudo-inverse method to generate the preliminarily processed signals; or, after performing beamforming algorithm, the processor 15 can perform further separation using Tikhonov Regularization (TIKR) to generate the preliminarily processed signals with better sound quality (less noise). More specifically, the processor 15 can reproduce the signals originally generated by the sound sources from the input signals received by the sound receiving elements 11a and 11b (i.e. generating preliminarily processed signals that are similar to the original signals output from the sound sources) by TIKR method and based on a matrix of a set of steering vectors of multiple angles (directions).

In step S14, the processor 15 filters each of the preliminarily processed signals using HRTF, so as to generate a left channel signal LS and a right channel signal RS corresponding to each preliminarily processed signal. In this way, the generated audio signals can be more directional and have the better effect of presence.

In step S15, the processor 15 generates a left channel signal set according to the left channel signal LS corresponding to each of the preliminarily processed signals, and generates a right channel signal set according to the right channel signal RS corresponding to each of the preliminarily processed signals. In particular, the processor 15 sums up the left channel signals LS respectively corresponding to the preliminarily processed signals to obtain the left channel signal set, and sums up the right channel signals RS respectively corresponding to the preliminarily processed signals to obtain the right channel signal set.

Then, the processor 15 transmits the left channel signal set and the right channel signal set to the audio output elements 13a and 13b respectively for outputting the left channel signal set and the right channel signal set by the audio output elements 13a and 13b respectively. Especially, the 3D recording and playing method in FIG. 2 is more suitable for the implementation where the audio output elements 13a and 13b are headphones. In particular, the processor 15 transmits the left channel signal set to the left side of headphones for outputting the left channel signal set, and transmits the right channel signal set to the right side of headphones for outputting the right channel signal set.

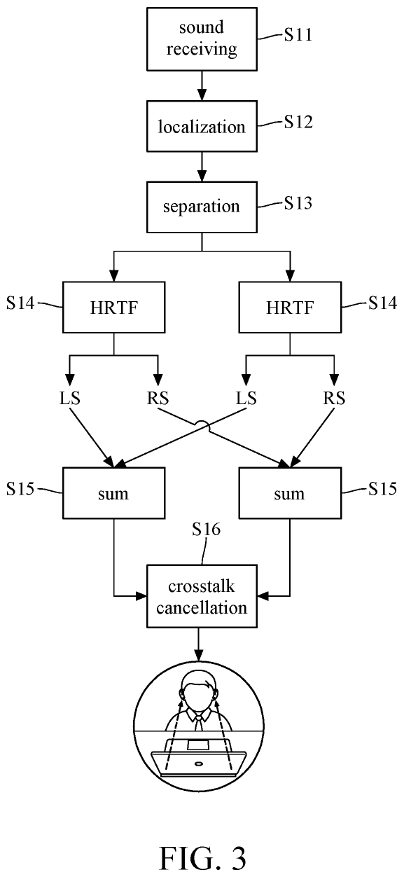

As above-mentioned, the 3D recording and playing method in FIG. 2 is more suitable for the implementation where the audio output elements 13a and 13b are headphones. For the implementation where the audio output elements 13a and 13b are speakers, please refer to FIG. 1 and FIG. 3, wherein FIG. 3 is a flow chart of a 3D recording and playing method according to another embodiment of this invention. The 3D recording and playing method shown in FIG. 3 is applied to the electronic device 1 as shown in FIG. 1, wherein the audio output elements 13a and 13b are headphones and the electronic device 1 is especially a laptop. However, this invention does not limit the 3D recording and playing method to only be applied to the electronic device 1 shown in FIG. 1.

As shown in FIG. 3, the 3D recording and playing method can comprise step S11 “sound receiving”, step S12 “localization”, step S13 “separation”, step S14 “HRTF”, step S15 “sum”, step S16 “crosstalk cancellation” (XTC) and the step of outputting the processed signal at the end, wherein the implementation of steps S11-S15 in FIG. 3 are the same as the implementation of steps S11-S15 in FIG. 2, so it is not repeated here. In other words, in comparison with the 3D recording and playing method shown in FIG. 2, the 3D recording and playing method shown in FIG. 3 further comprise step S16 for cancelling crosstalk. After performing steps 12-15 by the processor 15 to generate the left channel signal set and the right channel signal set, the electronic device 1 can further perform step S16 “crosstalk cancellation” for cancelling the crosstalk associated with the left channel signal set and the right channel signal set. In particular, the step of cancelling the crosstalk can comprise processing the left channel signal set by a first filter, and processing the right channel signal set by a second filter, and then the processed left channel signal set and the processed right channel signal set are respectively output by the audio output elements 13a and 13b. In this way, the user's left ear may merely hear the sound output by the left speaker, and the user's right ear may merely hear the sound output by the right speaker, wherein the left speaker and the right speakers respectively serve as the audio output elements 13a and 13b.

More particularly, the first and second filters can be matrices which are obtained based on a target matrix, a propagation matrix and a delay parameter, and particularly on the equation that the result of multiplication of the propagation matrix and a filter matrix is equal to the result of multiplication of the delay parameter and the target matrix, and TIKR algorithm is used to obtain the optimized filter matrix. The target matrix is set according to the ideal signal at the audio listening position (such as the left or right ear of the user); the propagation matrix indicates the relationship between the audio output elements 13a and 13b and the audio listening position, and particularly relates to head-related impulse responses (HRIR); the delay parameter is used for delaying the input signals. For example, with the left ear as the listening position, the parameter corresponding to the left side in the target matrix is set to 1, the parameter corresponding to the right side in the target matrix is set to 0, and the obtained filter matrix serves as the first filter; with the right ear as the listening position, the parameter corresponding to the right side in the target matrix is set to 1, the parameter corresponding to the left side in the target matrix is set to 1, and the obtained filter matrix serves as the second filter.

In view of the above, the 3D recording and playing method and the laptop with the function of 3D recording and playing disclosed by this invention process the sound received by sound receiving elements through localization, separation and HRTF to obtain audio signals having a stereo sound effect which allows a user to have a strong sense of the direction of sounds, as if the user's ears are listening near sound sources. Moreover, for speaker output, crosstalk cancellation processing is particularly added, so that the left and right ears may merely hear the sound of the left and right speakers respectively, and the sound effect of the speakers may be as that of headphones and more present.

What is claimed is:

1. A 3D recording and playing method applied to a laptop, wherein the laptop having a plurality of sound receiving elements and two audio output elements, and the method comprises:
receiving a plurality of input signals by the plurality of sound receiving elements;
localizing and separating the plurality of input signals so as to obtain a plurality of preliminarily processed signals;
for each of the plurality of preliminarily processed signals, filtering the preliminarily processed signal using a head related transfer function to generate a left channel signal and a right channel signal;
generating a left channel signal set according to the left channel signal corresponding to each of the plurality of preliminarily processed signals, and generating a right channel signal set according to the right channel signal corresponding to each of the plurality of preliminarily processed signals; and
outputting the left channel signal set and the right channel signal set by the two audio output elements respectively.

2. The 3D recording and playing method according to claim 1, wherein the two audio output elements are speakers, and the 3D recording and playing method further comprises cancelling crosstalk associated with the left channel signal set and the right channel signal set.

3. The 3D recording and playing method according to claim 2, wherein cancelling the crosstalk associated with the left channel signal set and the right channel signal set comprises processing the left channel signal set by a first filter, and processing the right channel signal set by a second filter.

4. The 3D recording and playing method according to claim 1, wherein localizing and separating the plurality of input signals is performed based on a beamforming algorithm.

5. The 3D recording and playing method according to claim 4, wherein the beamforming algorithm is one of delay-and-sum algorithm, minimum power distortionless response algorithm and minimum variance distortionless response algorithm.

6. A laptop with a function of 3D recording and playing, comprising:
a plurality of sound receiving elements configured to receive a plurality of input signals respectively;
two audio output elements; and
a processor connected with the plurality of receiving elements and the two audio output elements, and configured to localize and separate the plurality of input signals so as to obtain a plurality of preliminarily processed signals, for each of the plurality of preliminarily processed signals, filter the preliminarily processed signal using a head related transfer function to generate a left channel signal and a right channel signal, generate a left channel signal set according to the left channel signal corresponding to each of the plurality of preliminarily processed signals, generate a right channel signal set according to the right channel signal corresponding to each of the plurality of preliminarily processed signals, and output the left channel signal set and the right channel signal set by the two audio output elements respectively.

7. The laptop according to claim 6, wherein the two audio output elements are speakers, and the processor further cancels crosstalk associated with the left channel signal set and the right channel signal set.

8. The laptop according to claim 7, wherein the processor processes the left channel signal set by a first filter, and processes the right channel signal set by a second filter, so as to cancel the crosstalk associated with the left channel signal set and the right channel signal set.

9. The laptop according to claim 6, wherein the processor localizes and separate the plurality of input signals based on a beamforming algorithm.

10. The laptop according to claim 9, wherein the beamforming algorithm is one of delay-and-sum algorithm, minimum power distortionless response algorithm and minimum variance distortionless response algorithm.
